(19) United States
(12) Patent Application Publication
(10) Pub. No.: US 2018/0059275 A1
(43) Pub. Date: Mar. 1, 2018

(54) SYSTEM AND METHOD FOR MAPPING HORIZONS IN SEISMIC IMAGES

(71) Applicant: CHEVRON U.S.A. INC., San Ramon, CA (US)

(72) Inventors: Laura L. BANDURA, Houston, TX (US); Lisa R. GOGGIN, Houston, TX (US); Adam D. HALPERT, Houston, TX (US); Ke WANG, Houston, TX (US)

(21) Appl. No.: 15/252,378

(22) Filed: Aug. 31, 2016

(51) Int. Cl. G01V 1/36; G01V 1/30

(52) U.S. Cl. CPC G01V 1/36; G01V 2210/59; G01V 1/30

(57) ABSTRACT

A method is described for seismic imaging that may include receiving a partially flattened seismic image representative of a subsurface volume of interest; detecting moire patterns in the partially flattened seismic image; quantitatively characterizing the moire patterns; calculating flattening corrections based on the quantitatively characterized moire patterns; applying the flattening corrections to the partially flattened seismic image to generated a new flattened seismic image; and identifying geologic features based on the new flattened seismic image. The method may be executed by a computer system.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The disclosed embodiments relate generally to techniques for deriving seismic images of the subsurface from geophysical seismic data and, in particular, to a method of accurately mapping horizons in seismic images by improved flattening of the seismic events in order to facilitate exploration for and production of hydrocarbons.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors. The recorded waveforms (peaks and troughs, often referred to as seismic wavelets) are a quantitative characterization of the geologic boundaries, or subsurface reflectors. Seismic reflection occurs at every location where there is a change in rock or fluid properties. In addition to seismic data recorded in the field, it is also possible to generate synthetic seismic data with a computer that models the seismic sources and computes the propagation of the seismic energy, including reflections, and the seismic data that would be recorded at synthetic seismic sensors.

Seismic data is processed to create digital seismic images that can be interpreted to identify subsurface geologic features including hydrocarbon deposits. Continuous, coherent reflectors seen in the seismic image can be described as complex 3D surfaces with a trackable dip. 3-D digital seismic images may contain a nearly infinite number of these highly complex dipping surfaces.

The seismic wavelets' amplitude and phase respond directly to variations in rock and fluid properties, and depths at which these changes in properties occur are physical boundaries which may be computed from seismic data when they are properly mapped. It is critical that these data be mapped at the highest resolution possible in order to achieve an accurate subsurface description.

Manual seismic reflector mapping is slow but generally accurate and can yield only a very small set of reflector boundaries before project decisions must be made. Signal-dependent automated wavelet tracking is fast but becomes progressively inaccurate with decreasing signal-to-noise ratios. This approach can be automated to produce high-density depth determinations that capture all physical boundaries present within seismic images—a critical advance for seismic interpretation. Unfortunately, since a significant amount of uncertainty exists in any reflector-mapping approach, conventional ability to predict the positions of physical boundaries often falls short of accomplishing the perfect trace-to-trace alignment necessary to produce highly accurate maps. To facilitate the use of full-volume, automated reflector mapping, an automated method is needed to correct incorrectly mapped horizons.

The ability to define, at high granularity, the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for improved horizon mapping of seismic images that will facilitate enhanced exploration for and production of potential hydrocarbon reservoirs.

### SUMMARY

In accordance with some embodiments, a method of seismic imaging may include receiving a partially flattened seismic image representative of a subsurface volume of interest; detecting moire patterns in the partially flattened seismic image; quantitatively characterizing the moire patterns; calculating flattening corrections based on the quantitatively characterized moire patterns; applying the flattening corrections to the partially flattened seismic image to generated a new flattened seismic image; and identifying geologic features based on the new flattened seismic image.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates a flowchart of a method of seismic imaging including horizon mapping, in accordance with some embodiments;

FIG. 2 illustrates a flowchart of an embodiment of one of the steps of the method in FIG. 1;

FIG. 3 is an example of a conventionally flattened seismic imaging with banding;

FIG. 4A is a diagram of a moire pattern;

FIG. 4B is a diagram of a moire pattern on adjacent tau-surfaces;

FIG. 4C is a diagram illustrating the shifts indicated by the moire bands; and

FIG. 5 is a block diagram illustrating a seismic imaging system, in accordance with some embodiments.

Like reference numerals refer to corresponding parts throughout the drawings.

### DETAILED DESCRIPTION OF EMBODIMENTS

Described below are methods, systems, and computer readable storage media that provide a manner of seismic imaging. These embodiments are designed to be of particular use for seismic imaging of subsurface volumes including horizon mapping.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

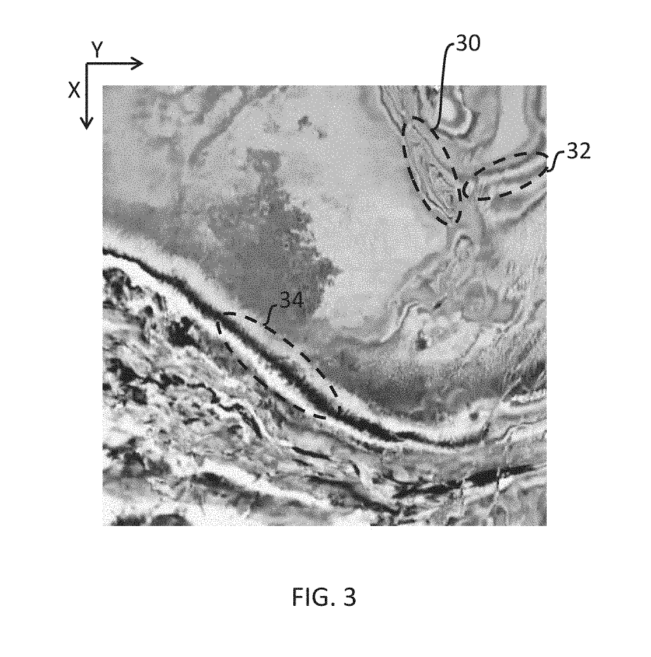

Seismic imaging of the subsurface is used to identify potential hydrocarbon reservoirs. Seismic data is acquired at a surface (e.g. the earth's surface, ocean's surface, or at the ocean bottom) as seismic traces which collectively make up the seismic dataset. The seismic data is processed to generate digital seismic images. For decision-making purposes, the location of subsurface rock boundaries is communicated using seismic mapping, the process by which rugose 3-dimensional rock boundaries are displayed on a flat plane using a computer. Existing seismic interpretation software packages such as Schlumberger's Petrel and Paradigm's EPOS suite allow rapid movement of planar viewing surfaces (vertical and horizontal) through 3D seismic images. In order to efficiently review all available information within a 3D seismic image, it is desirable to translate all dipping seismic reflections onto planar surfaces through a process referred to as “volumetric flattening”. When a seismic image is properly flattened, the rapid movement of a horizontal visualization plane through the data reveals the morphological form of and facies changes associated with geologic boundaries. If the calculation by which flattening is performed is retained and an inverse transform of this computation is applied, the depth or time to any of the nearly infinite surfaces may be determined. When discordance exists between this planar viewing surface and the seismic reflectors, moire patterns (a type of imaging artifact created by inaccuracies in trace-to-trace phase correlation) are evident, as seen in FIG. 3 where areas 30, 32, and 34 show banding. Moire patterns exhibit predictable visible sweep when the viewing plane is moved up or down through the seismic volume. This predictable sweep is a function of the measurable discordance between the viewing plane and the incorrectly mapped reflector in flattened space. To fully benefit from volumetric flattening, it is necessary to remove recognizable discordance between the viewing plane and the mapped geologic surfaces.

The present invention includes embodiments of a method and system for seismic imaging including horizon mapping. The improved flattening of the present invention improves the digital seismic image such that a horizontal viewing plane used by the computer to display the morphological form of and facies changes associated with geologic boundaries does not have the discordance seen in conventional flattening methods. This improves decisions impacting budgetary planning, obtaining mineral and lease rights, signing well commitments, permitting rig locations, designing well paths and drilling strategy, preventing subsurface integrity issues, planning proper casing and cementation strategies, and selecting and purchasing appropriate completion and production equipment.

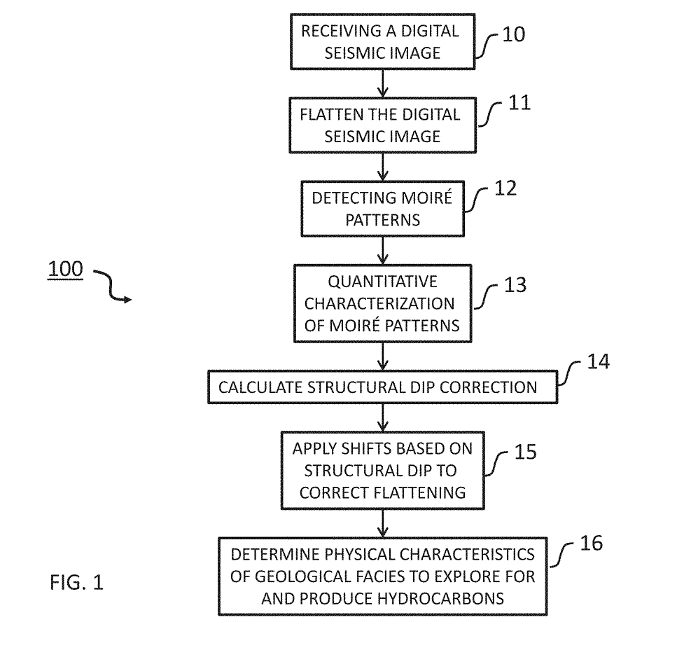

FIG. 1 illustrates a flowchart of a method 100 for seismic imaging including horizon mapping. At operation 10, a digital seismic image is received. As previously described, a seismic dataset including a plurality of traces was recorded at a plurality of seismic sensors, either in the field or as a synthetic seismic survey modeled by a computer. The seismic image is generated from a seismic dataset that may have been subjected to a number of seismic processing steps, such as deghosting, multiple removal, spectral shaping, and some type of seismic imaging such as migration. These examples are not meant to be limiting. Those of skill in the art will appreciate that there are a number of useful seismic processing steps that may be applied to seismic data to create a seismic image.

At operation 11, the digital seismic image is flattened. The flattening can be done in a number of ways. For example, the flattening may be accomplished based on the method described by U.S. Pat. No. 7,769,546, Method for Indexing a Subsurface Volume For The Purpose of Inferring Geologic Information, or U.S. patent application Ser. No. 14/595,964, System and Method for Generating a Depositional Sequence Volume from Seismic Data. Either of these methods may produce so-called tau-volumes, which provide the transform between seismic sample locations in the raw cube (original seismic image) and locations in the flattened cube (flattened seismic image). Although these flattening methods produce a flattened volume, in general there are areas where the seismic events are not completely flattened. This often occurs where the subsurface is complex, such as faulted regions and near geologic features including anticlines, synclines, and salt bodies.

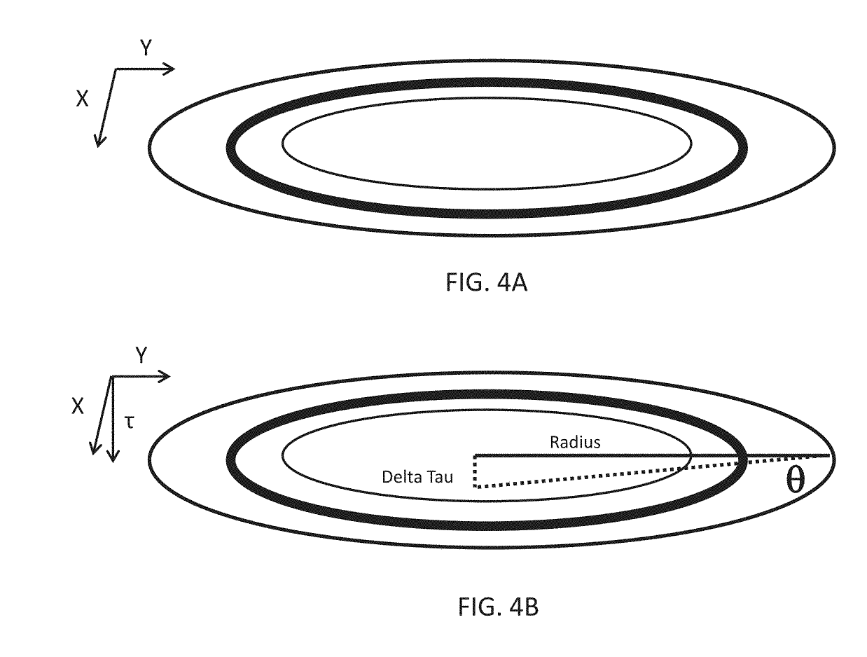

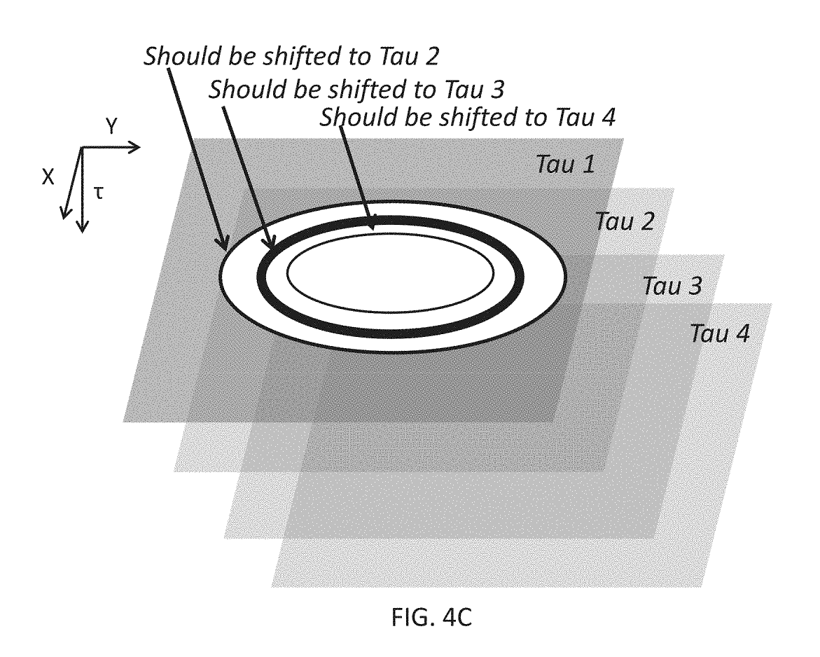

As explained above, the flattened seismic image may not have completely flattened all of the seismic reflectors across the entire seismic volume. If a horizontal viewing plane is applied by the computer, the discordance between the horizontal viewing plane and the imperfectly flattened image can be seen. This is illustrated in FIG. 3 and FIG. 4A.

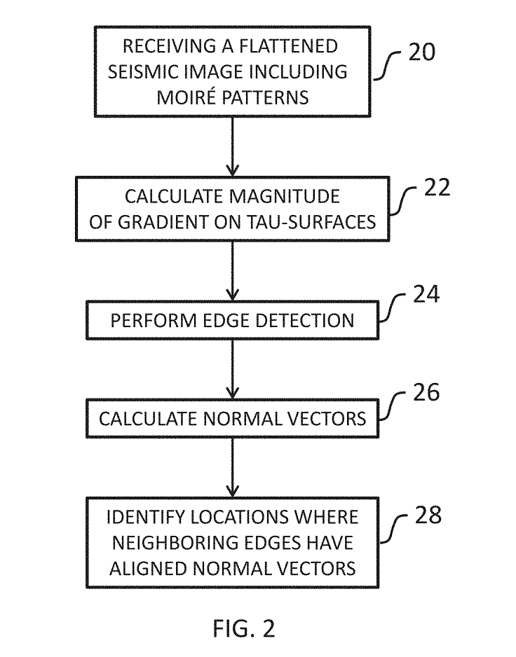

Referring again to FIG. 1, the flattened seismic image is analyzed to detect moire patterns 12. Detecting moire patterns may be done by visual inspection or by an automated process by the computer. For example, detecting the moire pattern might be done using a method such as described in FIG. 2. A flattened seismic image with moire patterns is received 20. The image is analyzed on each tau-surface, which is a horizontal plane in the flattened domain for which tau is constant in order to calculate the magnitude of the gradient of the events. This is done at high resolution to get as much detail as possible. Once the gradients on each tau-surface are calculated, edge detection is performed 24. A classic edge-detection method is the Canny algorithm; other commonly-used image processing filters designed to enhance edges include the Sobel and Gabor filters. After the edges have been detected, the normal vectors are calculated for each edge 26. It is then possible to identify locations where concentric or subsequent band edges have aligned normal vectors 28 which will be patterns with a stripe/band or ring nature, as moire patterns have.

Referring again to FIG. 1, once the moire patterns have been detected 12 it becomes possible to quantitatively characterize the moire patterns 13. To do this, the moire patterns identified on each tau-surface in operation 12 are compared with moire patterns on adjacent tau-surfaces, which can be thought of as the horizontal slice above and below. Similar moire patterns on the adjacent tau-surfaces may be automatically identified and associated with each other. In principle, for a concentric, elliptical banding pattern, one may search for the maximum size band associated with the pattern and count the bands within the outer band to determine the number of reflections which were cross-cut. This is illustrated in FIG. 4B. A typical, regularly-spaced tau-volume will allow for easy calculation of the bulk correction needed for the region defined by the outer ellipse. For linear or more complex patterns, similar methods may be used. It is important to note that this 2D projection is a 3D measurement of the error and the banding pattern thickness and frequency is a direct, quantitative measure of the needed correction (true dip) to eliminate the pattern. For example, closely-spaced high order bands could mean a large jump of the tau surface over multiple horizons occurring over a short distance. A good analogy is that the tau surfaces with the artifacts are a topographical map of the residual error in the dip estimation at all locations in the flattened seismic volume.

Referring again to FIG. 1, once the moire patterns have been quantitatively characterized 13, it is possible to calculate the dip corrections in order to obtain the true structural dip 14. The dip correction can be calculated as

$${Dip}_{corr} = θ = {tan}^{- 1} \frac{Δ τ}{r}$$

where the θ is shown in FIG. 4B, Ar is Delta tau which is constant between tau-surfaces, and r is the radius. These dip corrections can then be used to correct the flattening of the image 15. FIG. 4C illustrates how four moire bands should be corrected to different tau-surfaces based on this calculation. Conventional technology requires interpreters to manually correct semi-automated dip-computed surfaces through a time-intensive digitizing procedure. Because moire patterns are directly related to the direction and magnitude of error in dip estimation, they may be used to automatically correct inaccurate dip computations. This method of quantitative measurement is historically performed in several areas of science and is known as a form of interferometry-based metrology often referred to as “deflectometry” or “profilometry” (see, for example, Chiang and Kao, 1979) Most of these methods are light-based and require a type of projector; however, the same principles apply to the reflection of seismic waves and the images based on these reflections.

There are known formulae describing moire patterns that may be modified and subsequently utilized for the purpose of correcting an ill-flattened image (see, for example, Creath and Wyant, 1992 and Canabal et al., 1998). Also, given the nature of the parametric equations describing these artifacts, the image correction algorithm can be reduced to a least-squares problem that may be automated.

Once errors in dip estimation are corrected, observed lateral trace-to-trace amplitude and phase variations, viewed on flattened dip-parallel surfaces, will accurately sample geologically relevant seismic facies. Referring again to FIG. 1, the correctly flattened volume is used to determine the location and depth of changes in physical characteristics of geologic facies thus impacting hydrocarbon exploration and production success 16. The correctly flattened seismic image will facilitate rapid and accurate interpretations of geologic features, and improve the quality of operational decisions the interpretations support.

When interpreting a seismic image, seismic horizons are identified and traced throughout the subsurface volume of interest. Oftentimes, this volume of interest is near or below seismic attenuating or noise-inducing geologic bodies (for example, salt) that are often critical traps for potential hydrocarbon reservoirs. Improving the resolution of seismic events near or below such bodies improves interpretation. This may impact hydrocarbon reservoir delineation and well planning decisions.

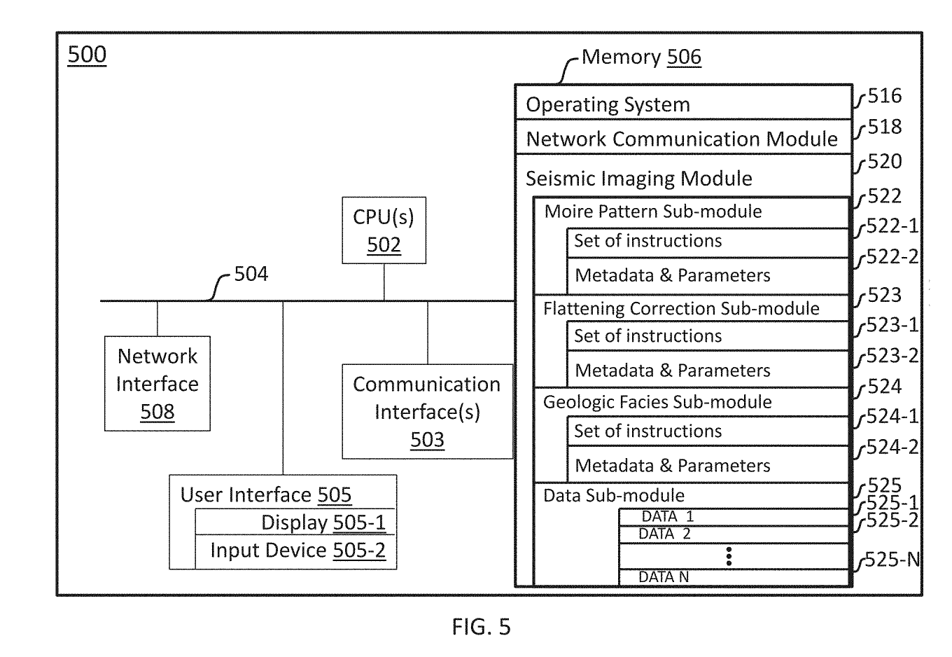

FIG. 5 is a block diagram illustrating a seismic imaging system 500, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the seismic imaging system 500 includes one or more processing units (CPUs) 502, one or more network interfaces 508 and/or other communications interfaces 503, memory 506, and one or more communication buses 504 for interconnecting these and various other components. The seismic imaging system 500 also includes a user interface 505 (e.g., a display 505-1 and an input device 505-2). The communication buses 504 may include circuitry (sometimes called a chipset) that interconnects and controls communications between system components. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPUs 502. Memory 506, including the non-volatile and volatile memory devices within memory 506, comprises a non-transitory computer readable storage medium and may store seismic data, seismic images, calculated dip corrections, and/or geologic structure information.

In some embodiments, memory 506 or the non-transitory computer readable storage medium of memory 506 stores the following programs, modules and data structures, or a subset thereof including an operating system 516, a network communication module 518, and a seismic imaging module 520.

The operating system 516 includes procedures for handling various basic system services and for performing hardware dependent tasks.

The network communication module 518 facilitates communication with other devices via the communication network interfaces 508 (wired or wireless) and one or more communication networks, such as the Internet, other wide area networks, local area networks, metropolitan area networks, and so on.

In some embodiments, the seismic imaging module 520 executes the operations of method 100. Seismic imaging module 520 may include data sub-module 525, which handles the seismic dataset including data 525-1 through 525-N which may be, for example, traces, gathers, or slices. This seismic data is supplied by data sub-module 525 to other sub-modules.

Moire pattern sub-module 522 contains a set of instructions 522-1 and accepts metadata and parameters 522-2 that will enable it to execute operation 12 and 13 of method 100. The flattering correction sub-module 523 contains a set of instructions 523-1 and accepts metadata and parameters 532-2 that will enable it to contribute to operations 14 and 15 of method 100. The geologic features sub-module 524 contains a set of instructions 524-1 and accepts metadata and parameters 524-2 that will enable it to execute at least operation 16 of method 100. Although specific operations have been identified for the sub-modules discussed herein, this is not meant to be limiting. Each sub-module may be configured to execute operations identified as being a part of other sub-modules, and may contain other instructions, metadata, and parameters that allow it to execute other operations of use in processing seismic data and generate the seismic image. For example, any of the sub-modules may optionally be able to generate a display that would be sent to and shown on the user interface display 505-1. In addition, any of the seismic data or processed seismic data products may be transmitted via the communication interface(s) 503 or the network interface 508 and may be stored in memory 506.

Method 100 is, optionally, governed by instructions that are stored in computer memory or a non-transitory computer readable storage medium (e.g., memory 506 in FIG. 5) and are executed by one or more processors (e.g., processors 502) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, method 100 is described as being performed by a computer system, although in some embodiments, various operations of method 100 are distributed across separate computer systems.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

### REFERENCES

F. P. Chiang and T. Y. Kao, “An Optical Method of Generating Slope and Curvature Contours of Bent Plates.” Int. J. Solids Structures Vol 15, 1979, pp.251-260
K. Creath, and J. C. Wyant, “Moire and fringe projection techniques, Ch16 [invited],” in Optical Shop Testing, 2nd Edition, D. Malacara, ed. (John Wiley and Sons, New York, 1992) pp. 653-685
Canabal et al.; “Automatic processing in moire deflectometry by local fringe direction calculation”; Applied Optics; vol. 37, No. 25; Sep. 1, 1998; pp. 5894-5901; Optical Society of America.

What is claimed is:

1. A computer-implemented method of seismic imaging, comprising:
a. receiving, at a computer processor, a digital partially-flattened seismic image representative of a subsurface volume of interest;
b. detecting moire patterns in the digital partially-flattened seismic image;
c. quantitatively characterizing the moire patterns;
d. calculating flattening corrections based on the quantitatively characterized moire patterns;
e. applying the flattening corrections to the digital partially-flattened seismic image to generated a new digital flattened seismic image; and
f. identifying geologic features based on the new digital flattened seismic image.

2. The method of claim 1 further comprising making a decision regarding budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment, or any combination thereof, based on the new digital flattened seismic image and the geologic features.

3. The method of claim 1 wherein the detecting moire patterns comprises calculating gradients of events on a tau-surface, performing edge detection on the gradients, calculating normal vectors from the edges, and identifying locations where neighboring edges have aligned normal vectors.

4. A computer system, comprising:
one or more processors;
memory; and
one or more programs, wherein the one or more programs are stored in the memory and configured to be executed by the one or more processors, the one or more programs including instructions that when executed by the one or more processors cause the device to:
a. receive a digital partially-flattened seismic image representative of a subsurface volume of interest;
b. detect moire patterns in the digital partially-flattened seismic image;
c. quantitatively characterize the moire patterns;
d. calculate flattening corrections based on the quantitatively characterized moire patterns;
e. apply the flattening corrections to the digital partially-flattened seismic image to generated a new digital flattened seismic image; and
f. identify geologic features based on the new digital flattened seismic image.

5. A non-transitory computer readable storage medium storing one or more programs, the one or more programs comprising instructions, which when executed by an electronic device with one or more processors and memory, cause the device to
a. receive a digital partially-flattened seismic image representative of a subsurface volume of interest;
b. detect moire patterns in the digital partially-flattened seismic image;
c. quantitatively characterize the moire patterns;
d. calculate flattening corrections based on the quantitatively characterized moire patterns;
e. apply the flattening corrections to the digital partially-flattened seismic image to generated a new digital flattened seismic image; and
f. identify geologic features based on the new digital flattened seismic image.
